(19) United States
(12) Patent Application Publication
(10) Pub. No.: US 2021/0007430 A1
(43) Pub. Date: Jan. 14, 2021

(54) Apparatus and a Method For The Application Of A Fluid Material To A Garment

(71) Applicant: Supercrease Limited, Leeds, Yorkshire (GB)

(72) Inventors: Kenneth Houlbrook, Leeds, Yorkshire (GB); Shaun Carter, Leeds, Yorkshire (GB)

(21) Appl. No.: 16/617,256

(22) PCT Filed: Apr. 4, 2019
(86) PCT No.: PCT/GB2019/050980

§ 371 Date: Nov. 26, 2019

(30) Foreign Application Priority Data
Apr. 6, 2018 (GB) 1805759.5
Jan. 8, 2019 (GB) 1900257.5

(51) Int. Cl. A41H 43/00; B05C 17/005; B05C 17/01; A41D 1/10

(52) U.S. Cl. CPC A41H 43/00; A41D 1/10; B05C 17/01; B05C 17/00596

(57) ABSTRACT

Apparatus and method for the application of a ribbon of fluid material along one or more garment crease lines by relative movement between one or more cartridges which include a reservoir in which the fluid material is provided, and the garment, the one or more cartridges including a dispensing aperture in connection with the reservoir and through which the fluid material is dispensed. Movement means are provided in the one or more cartridges to encourage the fluid material in the cartridge to move towards the dispensing aperture and a pressurised fluid supply is connected to the one or more cartridges to selectively provide pressurised fluid to the movement means and hand operated user actuable control means are provided to allow the selective provision of the pressurised fluid. The provision of hand operation of the user actuable control means allows the apparatus to be significantly more compact. Preferably the operation of the user actuable control means and the movement of the one or more cartridges with respect to the one or more crease lines to dispense the fluid material can be achieved simultaneously by the same hand of the user.

The invention to which this application relates is apparatus which is provided for use in the application of a fluid material, typically a resin-like material, to a garment and, more particularly, the application of a relatively thin line, or ribbon, of the material along a crease line in the garment so as to allow when the material hardens, the crease to be retained in the garment for a longer period of time than would be the case if the resin was not present.

The provision of apparatus for this purpose is known and variations of the same have been in use for a considerable period of time. Conventionally, there is provided a reservoir of the resin material which is held in a cavity in a cartridge and the cartridge has an opening which leads to a dispensing nozzle with a slot through which the resin material passes to be dispensed therefrom. Relative movement between the cartridge and the garment along the crease line, allows a ribbon of the resin material to be dispensed therealong. Typically, the cartridge is moved with respect to the garment along the crease line and the crease line is located on a support which includes elongate groove formed in the same and into and along which the crease line of the garment is placed. The resin is applied to the crease line “V” which is on the exposed inner surface of the garment and thereby lies and hardens, along the inner crease. As the resin hardens so it retains the shape of the crease, during subsequent wearing of the garment.

The garment and support surface are typically provided at a height so as to allow the cartridge container to be gripped by the hand of a user and the user can then guide and move the cartridge along the crease line. The cartridge and/or a mounting means for the same, are typically provided with guide means along a linear axis which is typically the same as the longitudinal axis of the cartridge. In one embodiment the guide means are provided in the form of one or more fins formed or mounted as the cartridge and which are typically positioned so as to be moved along the crease line in advance of the application of the resin along the crease line.

The resin material in the reservoir is moved towards the dispensing nozzle under pressure in order to force the resin material through the dispensing nozzle and onto the garment, and in one embodiment, this is achieved by the provision of a piston within the cartridge which is provided to be moved from a first end of the cartridge reservoir progressively towards the dispensing nozzle at the opposing end so as to move the resin material through the dispensing slot. In order to move the piston, a pressurised gas supply, typically pressurised air, is connected to the cartridge at the said first end so that the pressured air, when it enters the cartridge, acts to move the piston. Conventionally, the control of the pressurised air supply is achieved via a foot pedal which is connected to pneumatic control means such that when the user operates the foot pedal, the pressurised air is supplied to the cartridge.

Conventionally therefore this means that in order to use the apparatus, a user is required to synchronise the operation of the foot pedal via their foot and the hand movement of the cartridge along the crease line so as to apply the resin material to the garment. This requires training of the user and is susceptible to error if one or both of the operation of the foot pedal or the movement of the cartridge is not achieved in a synchronised manner. It also means that the user is required to perform two separate operations at the same time which can be problematic and, furthermore, the foot pedal operating apparatus takes up space which may be at a premium in certain environments such as, for example, in a laundry or tailors, where there may be restricted space available for this type of apparatus.

An aim of the present invention is therefore to provide an improvement to the fluid material depositing apparatus so as to allow the material to be applied to the garment in a manner which achieves the application of the resin material to the crease line in an efficient and accurate manner whilst, at the same time, allowing the operation of the apparatus to be simplified.

In a first aspect of the invention there is provided apparatus for the application of a ribbon of fluid material along a crease line in a garment by relative movement between a cartridge which includes a reservoir in which the fluid material is provided, and the garment, said cartridge including a dispensing aperture in connection with the reservoir and through which the fluid material leaves the cartridge, movement means to encourage the fluid material in the cartridge to move towards the dispensing aperture and be dispensed therefrom and a pressurised fluid supply is connected to the cartridge to selectively provide pressurised fluid to the movement means to move the same and user actuable control means are provided to allow the selective provision of the pressurised fluid and wherein the user actuable control means are located so as to be operable by a hand of the user of the apparatus.

In one embodiment the user actuable control means are hand operable while the relative movement of the cartridge and garment occurs.

In one embodiment the user actuable control means are operable by the same hand as is used to cause the relative movement between the cartridge and garment.

In one embodiment the user actuable control means are positioned on the cartridge and/or mounting means therefore.

In one embodiment the garment is provided on a support with a groove along which the said crease line is located.

In one embodiment the user actuable control means are located on the support.

Typically the user actuable control means are located on, or adjacent to, the said cartridge at least when the commencement of the supply of the pressurised fluid is desired to commence.

In one embodiment, the said user actuable control means include a switch operable by the hand of a user prior to, during and/or after relative movement between the cartridge and the garment.

Typically the user operation of the switch allows the switching on and/or off of the pressurised fluid source to the cartridge.

In one embodiment, the pressurised fluid source is pressurised air and is part of a pneumatic supply system.

In one embodiment, the said switch is located on the mounting means with which the said cartridge is releasably located.

In one embodiment the said switch is are selectively positionable so as to allow the same to be moved to a selected position to improve ease of operation by the user.

In one embodiment, the mounting means has a plurality of arms which are shaped so as to receive and retain at least part of the body of the cartridge therewith, so that, in use the cartridge and mounting means are movable together along the crease line of the garment to dispense fluid material from the cartridge along the crease line.

In one embodiment, the mounting means includes location means so as to locate the same with respect to guide means provided on and/or for use with, the cartridge. In one embodiment, the guide means are one or more fins which are provided to be located along the crease line along which the fluid material is to be applied and which pass along the crease line in advance of the application of the fluid material.

In one embodiment, the mounting means is capable of receiving a single cartridge, in another embodiment the mounting means is capable of receiving two or more cartridges in a spaced apart substantially parallel relationship.

In one embodiment the mounting means includes a gripping portion which allows the mounting means and cartridge combination, to be gripped and guided along the crease line of the garment with the user capable of operating the said user actuable control means whilst holding the gripping portion.

In one embodiment the gripping portion is provided in a fixed position. In an alternative embodiment the gripping portion is movable with respect to the cartridge and/or mounting.

In one embodiment the gripping portion is pivotably movable around an axis which is substantially perpendicular to the axis along which the resin material is applied to the garment crease.

Typically where a plurality of cartridges are held by the mounting the user actuable control means allows control of the pressurised fluid source to both of the cartridges or, alternatively, user actuable control means may be provided for each of the cartridges so as to allow the same to be controlled independently.

In one embodiment the user actuable control means are provided to be acted upon by the user causing relative movement of the gripping portion with respect to the mounting means body.

In a further aspect of the invention there is provided a mounting means for at least one cartridge for dispensing a fluid material held within the at least one cartridge through a dispensing aperture, wherein said mounting means includes user actuable control means which are connected to a pressurised fluid source to allow the control of the supply of the pressurised fluid to the interior of the at least one cartridge to which it is connected so as to act on movement means within the cartridge and hence cause the selective dispensing of the fluid material therefrom.

In a further aspect of the invention, there is provided apparatus for the application of a ribbon of fluid material along the crease line of a garment, said apparatus including a cartridge having a body, guide means, a reservoir of the fluid material within the said body, and movement means provided to act on the fluid material to move the same towards a dispensing aperture of the cartridge, said movement means acted on by pressurised fluid from a pressurised fluid source connected to the interior of the cartridge and wherein the relative movement of the cartridge and garment and the control of the pressurised fluid source are achieved by a hand of the user of the apparatus.

In one embodiment the fluid material is a resin which is held in a sufficiently fluid condition in the cartridge so as to be dispensed therefrom and onto the garment crease line but after time, the resin cures to a hardened condition, to thereby act to retain the crease line in the garment.

In a further aspect of the invention there is provided apparatus including one or more cartridges having a reservoir of a fluid material which is dispensed therefrom via a dispensing aperture onto respective crease lines of one or more garments, said one or more cartridges held in position with respect to the respective crease lines via a mounting means to be gripped by an operator to allow the movement of the mounting means and one or more cartridges along the said crease lines as the fluid material is dispensed therefrom and the dispensation of the fluid material is achieved by selectively introducing a pressurised fluid to movement means to move the same and said fluid material along the reservoir and wherein the selective supply of the pressurised fluid is controlled by the user selectively moving a portion of the said mounting means to operate user actuable control means for the pressurised fluid supply. In one embodiment the said portion of the mounting means also acts as a handle which is gripped by the operator when moving the mounting means and one or more cartridges located therewith.

In one embodiment the said movement of the portion is in a direction which is substantially perpendicular to the direction of movement of the mounting means along the crease line.

In one embodiment the movement of the said portion is in a direction which is towards the said crease line and a support surface on which the garment is located.

In one embodiment the support surface includes a groove therealong and into and along which the crease line is positioned during the application of the fluid material thereto.

In one embodiment the said portion is slidably moveable with respect to the mounting means via a guide means so that the same, when the user applies a movement force is only moveable in one direction.

In one embodiment biasing means are provided so as to bias the said portion to a position at which the supply of the pressurised fluid is closed.

In one embodiment, when said portion is moved against the biasing means the pressurised fluid source is started and/or opened and the pressurised fluid is supplied into the cartridge reservoir so as to move a piston along the reservoir towards a dispensing nozzle of the cartridge and, as it does so, moves the fluid material so as to be dispensed through the nozzle in a controlled manner.

In one embodiment when the said user actuable control means is in the opened position, the pressurised fluid is supplied from an air pump connected to the cartridge via a supply tube.

In one embodiment the air pump is switched on by the movement of the said portion to an opened position.

In one embodiment a mounting means is provided with a switch which is air and/or electrically operated which is located on or adjacent to the mounting means and the movement of the said portion to an open position causes operation of the switch and hence operation of the pressurised fluid source.

In on embodiment the mounting means includes location positions for first and second cartridges which are spaced apart.

In one embodiment the said portion is positioned on the mounting means intermediate the said cartridges and when pressure is applied to move the said portion the movement force is applied substantially centrally of the mounting means.

In one embodiment the said gripping portion is held to simultaneously operate the pressurised fluid source and move the mounting means and the one or more cartridges along respective crease lines.

In one embodiment each cartridge is located on a first support assembly and a second support assembly and said first and second support assemblies are provided at spaced locations, typically along the longitudinal axis of said cartridges.

In one embodiment the cartridge is movable within a limited range of movement in a lateral direction to the longitudinal axis of the cartridges so as to allow any variation in the crease line and/or groove in the support surface to be taken into account as the cartridges are moved along the same and thereby enhance the ability of the resin which is applied to be applied to the base of the crease.

In a further aspect of the invention there is provided apparatus for the application of first and second lines of a fluid material along first and second crease lines of one or more garments simultaneously, said fluid material applied from first and second cartridges by the introduction of a pressured fluid into both cartridges and wherein the said pressurised fluid is provided from one or more air pumps and is selectively provided by the operation of user actuable control means to switch the said one or more air pumps on and/or off, said user actuable control means located at or adjacent to mounting means for the first and second cartridges.

In a further aspect of the invention there is provided a method for the application of a ribbon of fluid material along at least one crease line of one or more garments by providing the said at least one cartridge which includes a reservoir in which the fluid material is provided and said cartridge including a dispensing aperture in connection with the reservoir and through which the fluid material leaves the cartridge, causing relative movement between the said at least one cartridge and crease line as the aperture is guided along the crease line and dispensing said fluid material along the crease line by causing movement of movement means within the cartridge to encourage the fluid material to move towards and through the dispensing aperture by providing a pressurised fluid supply connected to the cartridge to selectively provide pressurised fluid to the movement means and user actuable control means are provided to allow the selective operation by a user to provide the said pressurised fluid to the at least one cartridge and wherein the user actuable control means are located so as to be operable by a hand of the user before, during and/or after the cartridge is moved along the said crease line.

Thus, in accordance with the invention, there is no need to provide for the foot operation of any part of the apparatus and therefore the foot pedal and associated apparatus is no longer required. As the user actuation means for the pressurised fluid source is provided as part of the mounting means for the cartridge, then the use of the apparatus is greatly improved and simplified and the space required to be made available for the apparatus is also greatly reduced.

Specific embodiments of the invention are now described with reference to the accompanying drawings; wherein

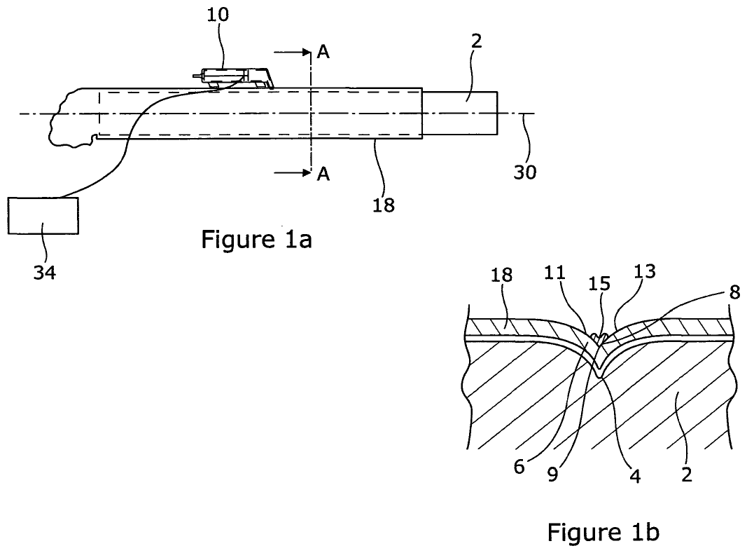

FIGS. 1a and b illustrate, schematically, apparatus in accordance with one embodiment of the invention;

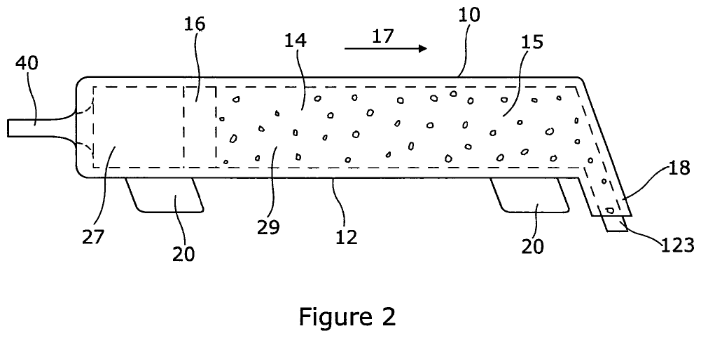

FIG. 2 illustrates a cartridge in accordance with one embodiment of the invention;

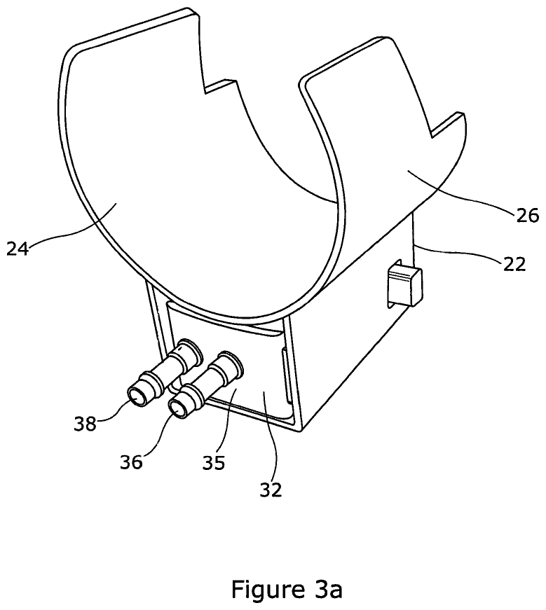

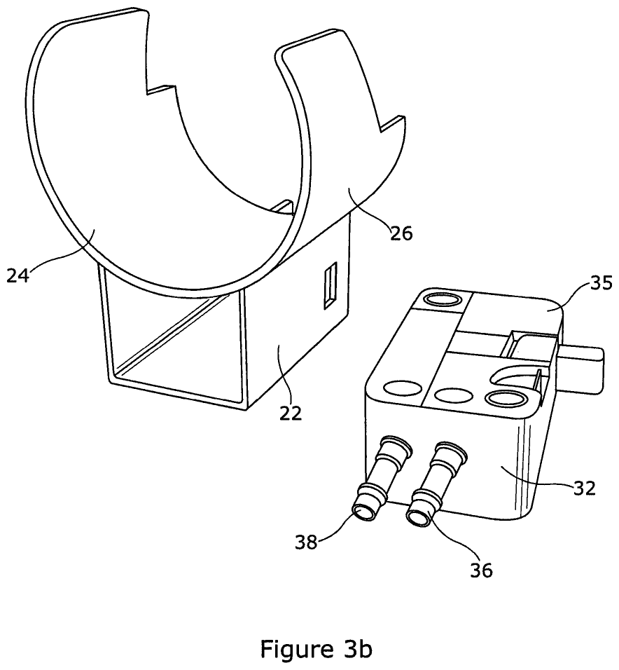

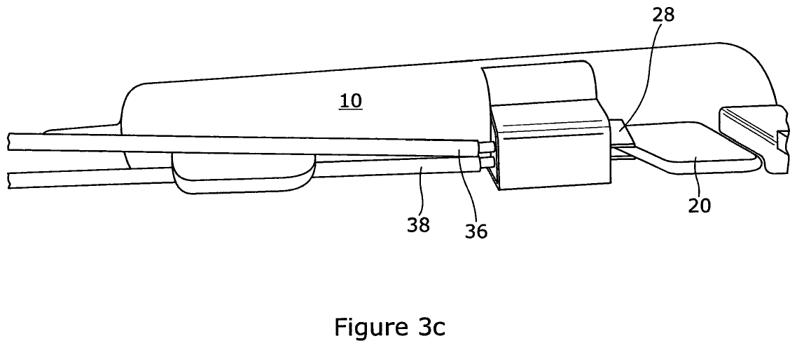

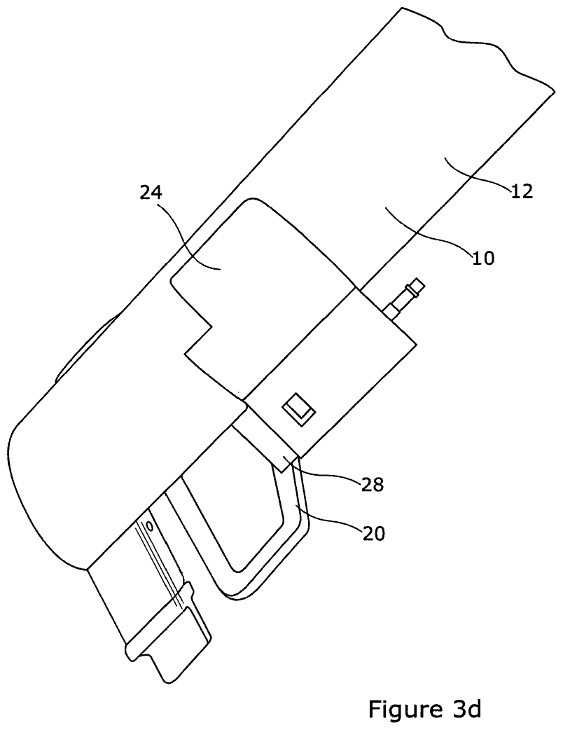

FIGS. 3a-d illustrate a first embodiment of a mounting means in accordance with the invention;

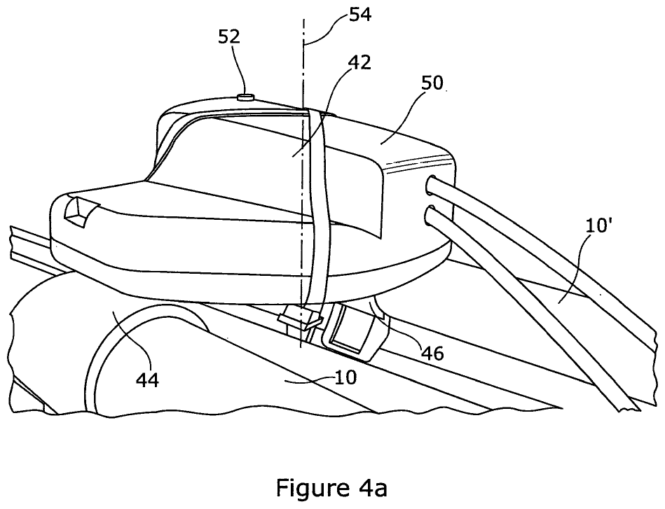

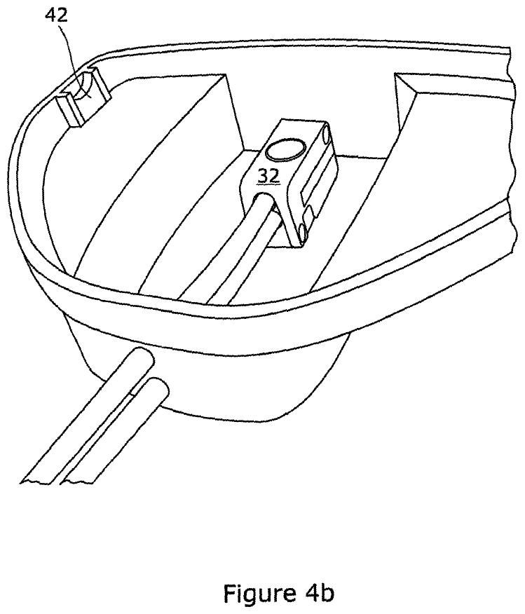

FIGS. 4a-b illustrate a second embodiment of a mounting means in accordance with the invention

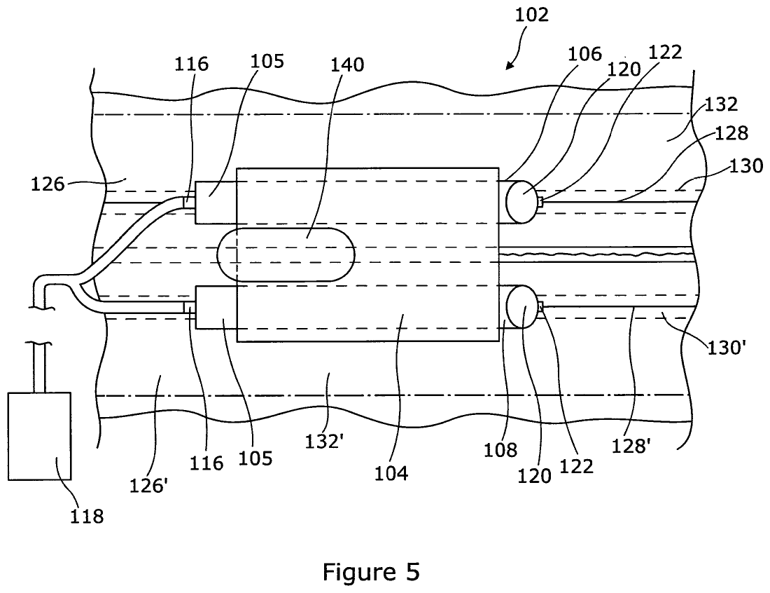

FIG. 5 illustrates in plan in a schematic manner a further embodiment of the invention in which there are provided a first and second cartridges held on a mounting means; and

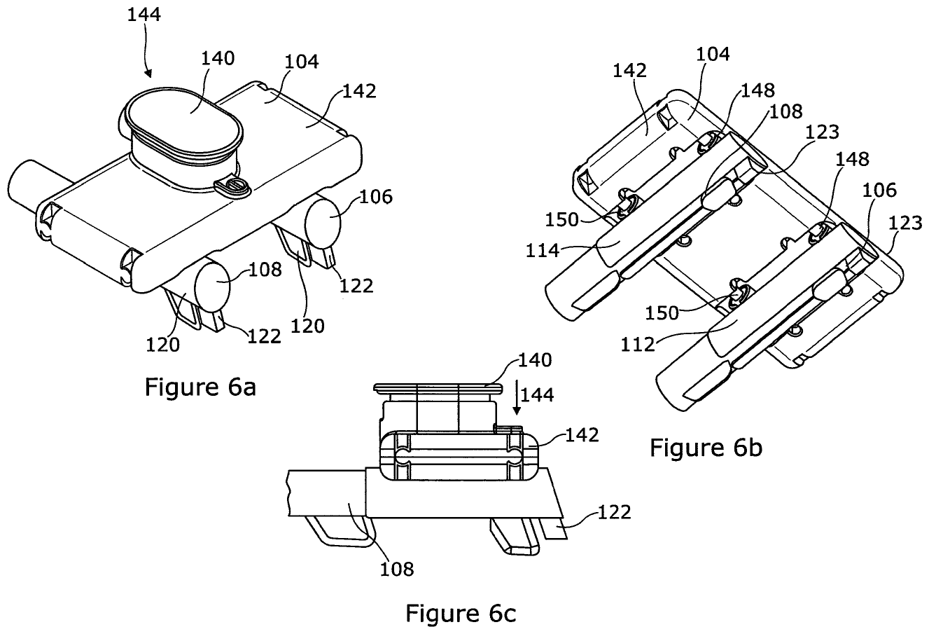

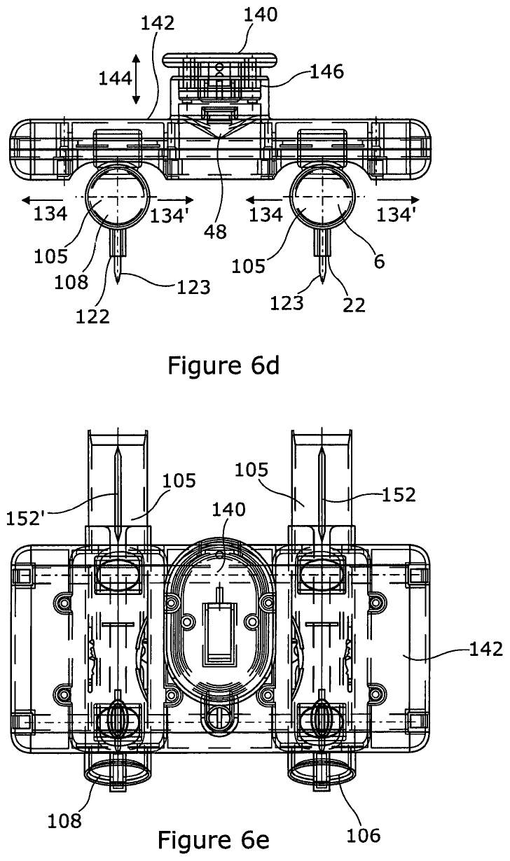

FIGS. 6a-e illustrate views of an embodiment of the apparatus in accordance with the invention.

Referring firstly to FIGS. 1a and b there is illustrated, in schematic form, components of the apparatus which are provided in accordance with one embodiment of the current invention. The components include a support surface or table 2 which has at least one groove 4 formed along at least a portion thereof. The groove can be V-shaped or gullwing-shaped 6, as illustrated in FIG. 1b, in cross-section and is provided, in use, to receive a crease line 8 of a garment 18 therealong. The crease line has a base 9 and side walls 11,13, as illustrated in FIG. 1b, which is a cross section along line A-A of the table and into and along the base 9 of the crease line 8, a fluid material resin 15 is applied to retain the shape of the crease when the resin material subsequently hardens.

The fluid resin material is dispensed from a cartridge 10 which is shown in more detail in FIG. 2. The cartridge has a body 12 in which there is formed a reservoir 14 in which the fluid resin material 15, is provided and a movement means, in the form of a piston 16 is provided to be moved linearly along the interior of the cartridge body to encourage the fluid resin material to flow towards a dispensing nozzle 18 which has a slot 123 through which the fluid resin material 15 flows to leave the cartridge and to be applied onto and along the garment crease line, typically at the same time as the cartridge is moved along the crease line so as to form a ribbon or line of the fluid resin material therealong. The fluid resin material is moved out of the cartridge through the aperture 123 under the influence of the piston 16 located in the cavity as the piston is moved by the provision of the pressurised air which enters into the cavity to one side 27 of the piston, with the fluid resin material 15 being located on the other side 29 of the piston and at the end of which side the dispensing aperture 123 is located. Thus, the appropriate pressure of the pressurised air, in combination with the movement of the cartridge along the crease line allows the fluid resin material 15 to be applied from the aperture 123 onto the crease line in the required amount.

The cartridge movement along the crease line is guided by guide means 20 on or located with the cartridge and the guide means are moved along the crease line in the garment in advance of the aperture 123 as the cartridge is moved therealong and the groove on the support surface further guides the cartridge therealong so that the application of the fluid to be along the base 9 of the crease line.

A mounting means 22 in accordance with the invention is shown in one embodiment in FIG. 3a and the mounting means has arms 24 and 26, which exert a clamping force on the cartridge body 12 so as to retain the cartridge 10 therewith, as shown in FIGS. 3c and d. In this embodiment, the mounting means also includes location means 28 which locate with one of the guide means 20 on the cartridge 10 so as to retain the cartridge and mounting in the required linear relationship along the longitudinal axis 30 of the groove 4.

Also provided is a user actuable control means which, in one embodiment includes a switch mechanism 32. The user actuable control means can be located on or adjacent to the cartridge 10, on the support surface or table 2, and/or may be movable so as to be at least temporarily located at a position so as to allow the same to be hand operable by the user of the apparatus and further preferably be hand operated by the user before, during and/or after the relative movement of the cartridge and garment to dispense the fluid resin material along the crease line. Yet further preferable is for the user actuable control means to be operable by the same hand of the user which they use to move the cartridge with respect to the garment. One example of how this can be achieved is to provide the user actuable control means switch mechanism and a housing 35 located in the mounting means for the cartridge. The switch mechanism allows an air pump 34 which is the pressurised fluid source to be switched on and off. In this embodiment the switch mechanism has an air supply inlet 36 and outlet 38. The inlet 36 is connected to the air pump 34 and the outlet 38 leads to an inlet 40 into the cartridge 10 interior and when the pressurised air is supplied into the cartridge interior, the movement force is applied to the piston 16 to move the same along the fluid material reservoir and hence move the fluid resin material 15 towards the dispensing aperture 123. Thus, in accordance with the invention the user operation and the supply of pressurised air to the cartridge, is controlled by the selective operation of the user actuable means on the mounting means 22 for the cartridge and, so the user can operate the user actuable means by their hand, and typically using the same hand as is used to grip the cartridge to move the same along the crease line during the application of the fluid.

In one embodiment the position of the switching means of the user actuable control means can be adjusted with respect to the body of the mounting means so as to allow the same to be positioned to be most easily usable by the user with respect to, for example, whether they are right or left handed.

There is therefore no longer the need for any foot pedal or foot operation to control the pressurised air supply.

As the cartridges are typically disposable once the fluid material has been dispensed therefrom, it will be appreciated that the mounting means can be separated from the empty cartridge and a new, filled, cartridge is then inserted, as required, from time to time.

FIGS. 4a-b illustrate an alternative embodiment of the invention in which there is provided a mounting means 42 for first and second cartridges 10, 10′ which are held in a spaced, substantially parallel, relationship as illustrated which shows a perspective view of the mounting means. In this case, the mounting means has two separate sets of engagement means 44, 46 for the respective cartridges and, intermediate the engagement means, there is provided a portion which includes a gripping portion in the form of a handle 50 so as to allow the mounting to be gripped and at, or adjacent to, the handle 50, there is located the user actuable control means 32 in the form of a switch button 52 which can be operated by the hand of the user when gripping the handle 50 so as to allow the selective supply of pressurised air to both cartridges and, when supplied, to allow the pistons 16 in the respective cartridges to simultaneously move the fluid from the cartridges 10, 10′ out of the respective dispensing nozzle apertures 123, 123′. In this case the remainder of the user actuable control means 32 is located on the underside of the mounting 42 as illustrated in FIG. 4b.

In one embodiment, the gripping portion handle 50 is provided in a fixed position. Alternatively the gripping portion handle 50 is adjustable so that in one arrangement the same moves as the cartridges are moved along the grooves in the support table and hence along a crease positioned therealong. In one embodiment the gripping portion 50 is initially in line with the direction of travel of the cartridges and as the gripping portion is being gripped by the user to move the same then when the twin cartridges are moved past the user's body, the gripping portion can rotate about axis 54. This movement avoids undue strain on the hand used to grip the gripping means 50 and also allows the cartridges to be moved along the full length of the crease and grooves in one movement action.

Referring now to the FIGS. 5 and 6a-e, there is illustrated apparatus in accordance with a further embodiment of the invention. In this embodiment the apparatus 102, includes a mounting means 104 with which are selectively located in respective location means, first and second cartridges 106,108. The cartridges are releasably connectable to the mounting means 104 so as to allow the replacement of the same when they become empty of the fluid material resin which is provided within a reservoir cavity in the body 105 of the cartridge.

The cartridges can be as shown in FIG. 2. The cartridges includes a connection 116 to a pressurised fluid source 118 which, in this embodiment, is an air pump typically located on a floor of the room in which the apparatus is located. At or adjacent to the opposing end 120 of the cartridges, there is provided a dispensing formation including a nozzle 122 which has a channel leading to an aperture 123 to allow a quantity of the resin material to flow from the reservoir through the said aperture and onto the crease line under the influence of the movement means in the form of the piston 16 as it is moved by the pressurised fluid along the reservoir in the body in the direction of arrow 17 as shown in FIG. 2.

The assembly is provided to be used in the application of the fluid resin material from the respective cartridges 106, 108 so that a first line or ribbon of fluid resin material is applied from the first cartridge 106 and a second line of fluid resin material is applied from the second cartridge 108 in parallel and along the base of the crease lines 130, 130′ in one or more garments, such as legs 126, 126′ of a pair of trousers which are located on a support surface 132, 132′. The support surface has formed therein first and second grooves 128, 128′ which are provided in substantially the same spaced apart distance as are the apertures 123, 123′ of the respective cartridges 106, 108 when held in the mounting means 104 so that, when the creases 130, 130′ are in location along the respective grooves 128, 128′ then the lines of fluid resin material are applied along the base of the respective crease lines and then the resin material subsequently hardens so as to act to prolong the retention of the crease lines in the garment.

The mounting means 104 can include some resilience in terms of allowing sideways movement of the respective cartridges as indicated by arrows 134,134′ with respect to their longitudinal axis 152, 152′ so that any deviation in the crease line 130,130′ or groove 128, 128′ along which the cartridges are moved, can be taken into account to thereby try to ensure that the lines of fluid resin material are applied along the base of the crease lines when in location along the grooves rather than on a sidewall of the crease line as this can adversely affect the quality of the resin application.

In the present invention, the operation of the air pump 118 to allow the pressurised air to be provided, is achieved by the operator using their hand and, typically the same hand which is used to move the mounting means 104 along the crease lines, by gripping a portion 140 of the mounting means which includes or acts on user actuable control means for the supply of the pressurised air. The portion 140, can be of any suitable shape and preferably is shaped so as to be ergonomically effective when gripped and allow the mounting means 104 to be moved to slide the cartridges 106,108 along the crease lines. There is a significant advantage in terms of efficiency, comfort and usage of available space, in being able to use the same portion 140 to allow the operation of the user actuable control means for the pressurised air supply and, at the same time, the movement of the mounting means.

In this embodiment, to operate the pressurised fluid supply the user grips the portion 140 and applies a force to the same, typically downwardly towards the body 142 of the mounting means 104 as illustrated by arrow 144, and this acts to operate user actuable control means in the form of an air or electrical switch 148 which is located in the mounting means between the portion 140 and the body 142. The movement of the portion 140 to operate the switch 148, is typically guided by guide means 146 which allow smooth movement of the portion 140 so that the application of the movement force downwardly on the portion 140 and the movement of the same with respect to the mounting means, downwardly and upwardly, does not adversely affect the position of the portion 140, and hence the mounting means 104, as it is also being gripped by the user's hand to move the mounting means 104 and cartridges 106,108 along the crease lines 128, 128′ and so does not have any adverse effect on the guidance of the application of the fluid resin material onto the garment crease line or lines when the pressurised fluid supply is switched on by the user actuable control means.

In one embodiment, the switch 148 includes a body and switch portion which is resiliently biased to a raised position away from the body 142 in which case the pressurised fluid supply is switched off and the pump 18 is not operated as a default position. The switch is positioned so that the application of the downward force 144 via the user's hand on the portion 140, acts against the biasing force and moves the switch 148 to an on position which in turn operates, electrically, the pump 118 via a connection cable to then allow the pressurised fluid to be provided from the pump 118 to each of the cartridges 106,108 and in this embodiment the same pump 118 is used to supply the pressurised fluid to both cartridges 106,108.

Typically, each of the said cartridges 106, 108 are located on first and second support assemblies 148,150 which are provided at spaced locations along the longitudinal axes 152, 152′ of said cartridge so that the cartridges 106,108 are located and retained in a substantially parallel arrangement.

There is therefore provided an improved form of cartridge mounting means and also an improved manner of control of operation of the application of the fluid resin material from the one or more cartridges held by the mounting means onto the crease lines of the garment. The improved control system for the supply of pressurised air also means that the bulkiness of the apparatus is also significantly reduced thereby allowing the apparatus to be used in relatively confined spaces whilst ensuring that the supply of the resin material along the crease lines is effectively achieved.

1. Apparatus for the application of a ribbon of fluid material along a crease line in a garment by relative movement between a cartridge which includes a reservoir in which the fluid material is provided, and the garment, said cartridge including a dispensing aperture in connection with the reservoir and through which the fluid material leaves the cartridge, movement means to encourage the fluid material in the cartridge to move towards the dispensing aperture and be dispensed therefrom and a pressurised fluid supply is connected to the cartridge to selectively provide pressurised fluid to the movement means to move the same and user actuable control means are provided to allow the selective provision of the pressurised fluid and wherein the user actuable control means are located so as to be operable by a hand of the user of the apparatus.

2. Apparatus according to claim 1 wherein the user actuable control means are hand operable while the relative movement of the cartridge and garment occurs.

3. Apparatus according to claim 2 wherein the user actuable control means are operable by the same hand as is used to cause the relative movement between the cartridge and garment.

4. Apparatus according to claim 1 wherein the user actuable control means are positioned on the cartridge or mounting means therefore.

5. Apparatus according to claim 1 wherein the garment is provided on a support with a groove along which the said crease line is located.

6. Apparatus according to claim 5 wherein the user actuable control means are located on the support.

7. Apparatus according to claim 1 wherein the said user actuable control means include a switch operable by the hand of a user prior to, during and/or after relative movement between the cartridge and the garment.

8. Apparatus according to claim 7 wherein the user actuable control means allow the switching on and/or off of the supply of the pressurised fluid to the cartridge.

9. (canceled)

10. (canceled)

11. Apparatus according to claim 1 wherein the cartridge includes a retention formation which allows engagement between the cartridge and the mounting means during the application of the fluid material to the crease line of the garment.

12. Apparatus according to claim 1 wherein the user actuable control means are selectively positionable with respect to the cartridge, mounting means, garment and/or support to allow the same to be moved to a position to improve ease of operation by the user.

13. Apparatus according to claim 10 wherein the mounting means includes a body and a plurality of arms which are shaped so as to receive and retain at least part of the body of at least one cartridge therewith and guide means provided to guide the movement of the cartridge along the crease line.

14. (canceled)

15. (canceled)

16. Apparatus according to claim 4 wherein the mounting means is capable of receiving two or more cartridges and retaining the same in a spaced apart, substantially parallel, relationship, to allow simultaneous dispensing of fluid material from said two or more cartridges.

17. Apparatus according to claim 4 wherein the mounting means for the one or more cartridges includes a gripping portion which allows the mounting means to be gripped by the user's hand and the one or more cartridges located on the mounting means guided along the crease line of the garment with the user able to operate the said user actuable control means whilst holding the gripping portion.

18. (canceled)

19. Apparatus according to claim 17 wherein the gripping portion is moveable with respect to the cartridge and/or mounting means.

20. Apparatus according to claim 19 wherein the gripping portion is pivotally moveable around an axis which is substantially perpendicular to the axis along which the cartridge is moved to apply the fluid material along the crease line.

21. Apparatus according to claim 19 wherein movement of the gripping portion with respect to the mounting means causes operation of the user actuable control means.

22. Apparatus according to claim 1 wherein a plurality of cartridges are provided to dispense fluid material therefrom along respective crease lines simultaneously and the said user actuable control means allows control of the pressurised gas source to both of the cartridges.

23. A mounting means for at least one cartridge for dispensing a fluid material held within the at least one cartridge through a dispensing aperture, wherein said mounting means includes user actuable control means which are connected to a pressurised fluid source to allow the control of the supply of the pressurised fluid to the interior of the at least one cartridge to which it is connected so as to act on movement means within the cartridge and hence cause the selective dispensing of the fluid material therefrom.

24. Apparatus for the application of a ribbon of fluid material along the crease line of a garment, said apparatus including a cartridge having a body, guide means, a reservoir of the fluid material within the said body, and movement means provided to act on the fluid material to move the same towards a dispensing aperture of the cartridge, said movement means acted on by pressurised fluid from a pressurised fluid source connected to the interior of the cartridge and wherein the relative movement of the cartridge and garment and the control of the pressurised fluid source are achieved by a hand of the user of the apparatus via user actuable control means.

25. (canceled)

26. Apparatus including one or more cartridges having a reservoir of a fluid material which is dispensed therefrom via a dispensing aperture onto respective crease lines of one or more garments, said one or more cartridges held in position with respect to the respective crease lines via a mounting means to be gripped by an operator to allow the movement of the mounting means and one or more cartridges along the said crease lines as the fluid material is dispensed therefrom and the dispensation of the fluid material is achieved by selectively introducing a pressurised fluid to movement means to move the same and said fluid material along the reservoir and wherein the selective supply of the pressurised fluid is controlled by the user selectively moving a portion of the said mounting means to operate user actuable control means for the pressurised fluid supply.

27. Apparatus according to claim 26 wherein the said portion of the mounting means also acts as a gripping means gripped by the hand of the user when moving the mounting means and one or more cartridges located therewith.

28. Apparatus according to claim 26 wherein the said movement of the portion is in a direction which is substantially perpendicular to the direction of movement of the mounting means along the crease line.

29. (canceled)

30. Apparatus according to claim 29 wherein the support surface includes a groove therealong and into and along which the crease line is positioned during the application of the fluid material thereto.

31. Apparatus according to claim 26 wherein the said portion is slidably moveable with respect to the mounting means so that when the user applies a movement force the said portion is only moveable in one direction and biasing means are provided to bias the said portion to a position at which the supply of the pressurised fluid to the one or more cartridges is closed.

32. (canceled)

33. Apparatus according to claim 31 wherein when said portion is moved against the biasing means the pressurised fluid source is opened and the pressurised fluid is supplied into the cartridge reservoir so as to move a piston along the reservoir towards a dispensing aperture of the cartridge and, as it does so, moves the fluid material so as to be dispensed through the dispensing aperture in a controlled manner.

34. Apparatus according to claim 26 wherein the mounting means includes location positions for first and second cartridges which are spaced apart, and the said portion is positioned on the mounting means intermediate the said first and second cartridge locations and, when pressure is applied to move the said portion, the movement force is applied substantially centrally of the mounting means.

35. (canceled)

36. Apparatus according to claim 26 wherein the said gripping portion is held to simultaneously operate the pressurised fluid source and move the mounting means and the one or more cartridges along respective crease lines.

37. Apparatus according to claim 1 wherein the cartridge is movable within a limited range of movement in a lateral direction to the longitudinal axis of the cartridge so as to allow any variation in the crease line and/or groove in the support surface to be taken into account as the cartridge is moved along the same and thereby enhance the ability of the resin which is applied to be applied to the base of the crease.

38. Apparatus for the application of first and second lines of a fluid material along first and second crease lines of one or more garments simultaneously, said fluid material applied from first and second cartridges by the introduction of a pressured fluid into both cartridges and wherein the said pressurised fluid is provided from one or more air pumps and is selectively provided by the operation of user actuable control means to switch the said one or more air pumps on and/or off, said user actuable control means located at or adjacent to mounting means for the first and second cartridges.

39. (canceled)

40. Apparatus according to claim 38 wherein the user actuable control means includes a switch which is air and/or electrically operated and the movement of the said switch to an open position causes operation of the pressurised fluid source.

41. A method for the application of a ribbon of fluid material along at least one crease line of one or more garments by providing the said at least one cartridge which includes a reservoir in which the fluid material is provided and said cartridge including a dispensing aperture in connection with the reservoir and through which the fluid material leaves the cartridge, causing relative movement between the said at least one cartridge and crease line as the aperture is guided along the crease line and dispensing said fluid material along the crease line by causing movement of movement means within the cartridge to encourage the fluid material to move towards and through the dispensing aperture by providing a pressurised fluid supply connected to the cartridge to selectively provide pressurised fluid to the movement means and user actuable control means are provided to allow the selective operation by a user to provide the said pressurised fluid to the at least one cartridge and wherein the user actuable control means are located so as to be operable by a hand of the user before, during and/or after the cartridge is moved along the said crease line.
